(19) United States
(12) Patent Application Publication
(10) Pub. No.: US 2010/0325923 A1
(43) Pub. Date: Dec. 30, 2010

(54) Personalized card product

(76) Inventor: Linda Dial, Atlanta, GA (US)

Correspondence Address: KEATY LAW FIRM, LLC, 365 CANAL STREET, Suite 2410, NEW ORLEANS, LA, 70130, US

(21) Appl. No.: 12/459,125

(22) Filed: Jun. 26, 2009

(51) Int. Cl. G09F 1/00; G06F 17/00

(52) U.S. Cl. 40/124.03; 700/94

(57) ABSTRACT

A portable lightweight card houses an electronic circuit that has an audio card enabling a customized audio message to be recorded and selectively played back. An independent power supply in the form of a replaceable battery is positioned in a compartment that can be accessed from exterior of the housing, thereby extending message availability for play back indefinitely.

### BACKGROUND OF THE INVENTION

This invention relates to card products and, more particularly, to a method and apparatus for recording and delivering personalized audio messages. In particular, the present invention relates to systems and methods for generating devices such as greeting cards, posters, invitations and similar products with non-erasable personalized audio messages contained thereon.

The greeting card industry manufactures and sells greeting cards of many different types and for many different occasions. The greeting card is intended to assist consumers in expressing their feelings and/or in helping the consumers find the appropriate things to say at particular times. Greeting cards are often sent at holiday times, birthdays, anniversaries, etc. Greeting cards also often accompany gifts. Because of the great number of greeting cards available with many different messages, greeting cards attempt to inject a personal aspect to the communication. However, the message of the card rarely expresses exactly what the consumer wishes to say. Moreover, the messages imprinted in the body of the greeting cards are seldom personalized, leaving a blank space for the sender to add his/her words of greeting, encouragement, etc.

The greeting card industry also developed a talking greeting card which produces an audible message or greeting. The message may play a tune when the card is opened. The tunes are selected to be generic for a special occasion, be it a holiday, a life cycle event, or a humorous greeting preprogrammed by the manufacturer. This type of card provides the card with an audible message but does not allow the user to personalize the message.

The present invention contemplates elimination of drawbacks associated with the prior art and provision of a personalized greeting product that is small, lightweight, and allows the user to record an audio message for the recipient.

### SUMMARY OF THE INVENTION

It is, therefore, an object of the present invention to provide a personalized card product that allows a user to record and store a personalized audio message.

It is another object of the invention to provide a greeting card product that is lightweight and portable.

It is a further object of the invention to provide a greeting card product that is small enough to be incorporated in a flower arrangement in conjunction with conventional floral picks.

It is still another object of the invention to provide a personalized card product that allows the owner to change batteries and preserve the stored message indefinitely.

These and other objects of the invention are achieved through a provision of a device and method for recording and delivering a personalized audio message of a sender to a recipient. A lightweight portable housing has a bottom tab that allows the housing to be supported in a flower arrangement, in a gift basket and the like. An electronic circuit powered by an independent power supply comprises an audio board enabling a sound message to be recorded and played back.

A microphone and an audio board with a memory chip facilitate recording of a message that is then stored in the memory chip. A playback acoustic output member selectively plays back the stored personalized audio message upon demand.

### BRIEF DESCRIPTION OF THE DRAWINGS

Reference will now be made to the drawings, wherein like parts are designated by numerals, and wherein

FIG. 1 is a front view of the device in accordance with the present invention.

FIG. 2 is a back view of the device of the present invention.

FIG. 3 is a front view of the device of the present invention.

### DETAIL DESCRIPTION OF THE INVENTION

Turning now to the drawings in more detail, numeral 10 designates the personalized card product of the present invention. The device 10 comprises a casing 12 having a front panel 14 and a back panel 16 detachably secured to the front panel 12 by a plurality of securing members, such as screws 76. The front panel 14 has an outer face 20, and the back panel 16 has an outer face 26.

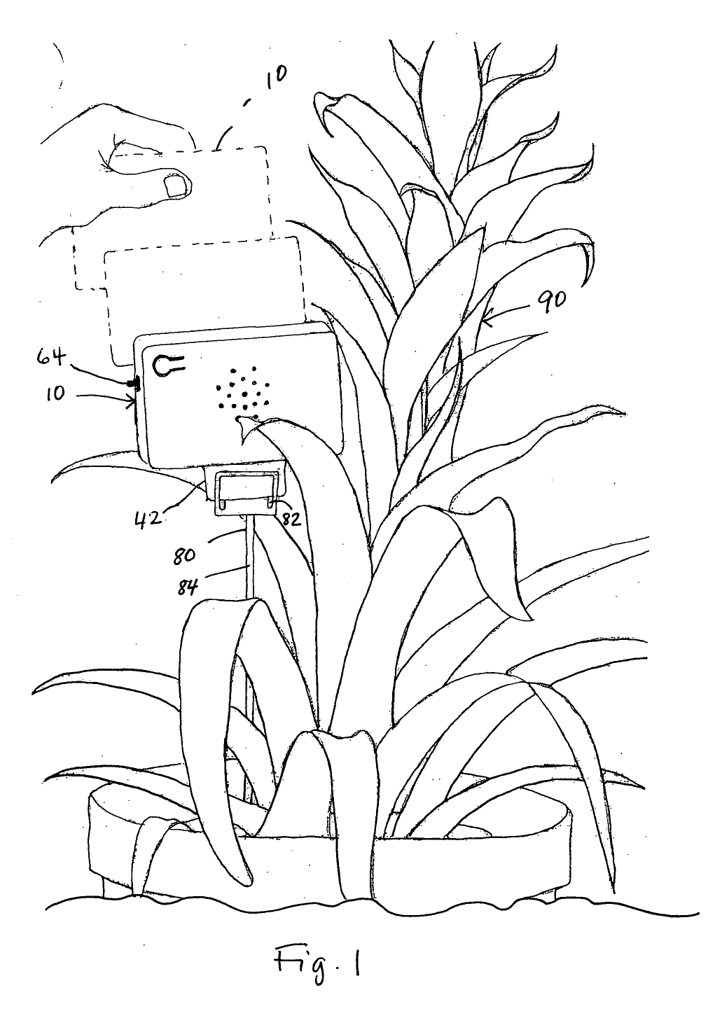

The front panel 12 has a first side 32 and an opposing second side 34. The back panel 16 has a first side 38, an opposing second side 40, and a supporting tab 42 contiguously connected to the second side 40. When the front panel 14 and the back panel 16 are secured together the 42 appears on the bottom of the device to be supported by a support member 80, as shown in FIG. 1.

The operating electronic circuit of the device of the present invention is secured between the inner surfaces of the front panel 14 and the back panel 16. It will be understood that the purposes of the instant invention may be achieved utilizing a variety of electronic components. One important component is an audio board 50, which has a printed circuit incorporated therein. The audio board 50 can comprise integrated circuit chips along with other electrical components to enable a voice to be recorded and played back. The audio board 50 may include a digital voice synthesizer and a memory chip for storing the audio message.

The electronic circuit of the device 10 also comprises an independent power supply, such as one or more replaceable batteries 54, an acoustical output device, or speaker 56, and an acoustic input device, or microphone 58. Record push buttons 60 and 62 are operationally connected to the audio input means 58. The buttons 60, 62 are pressed when user desired to record the message. An on/off switch 64 is mounted on the end of the casing 12. The on/off switch may be a sliding switch, if desired. A play button 52 is operationally connected to the audio board 50.

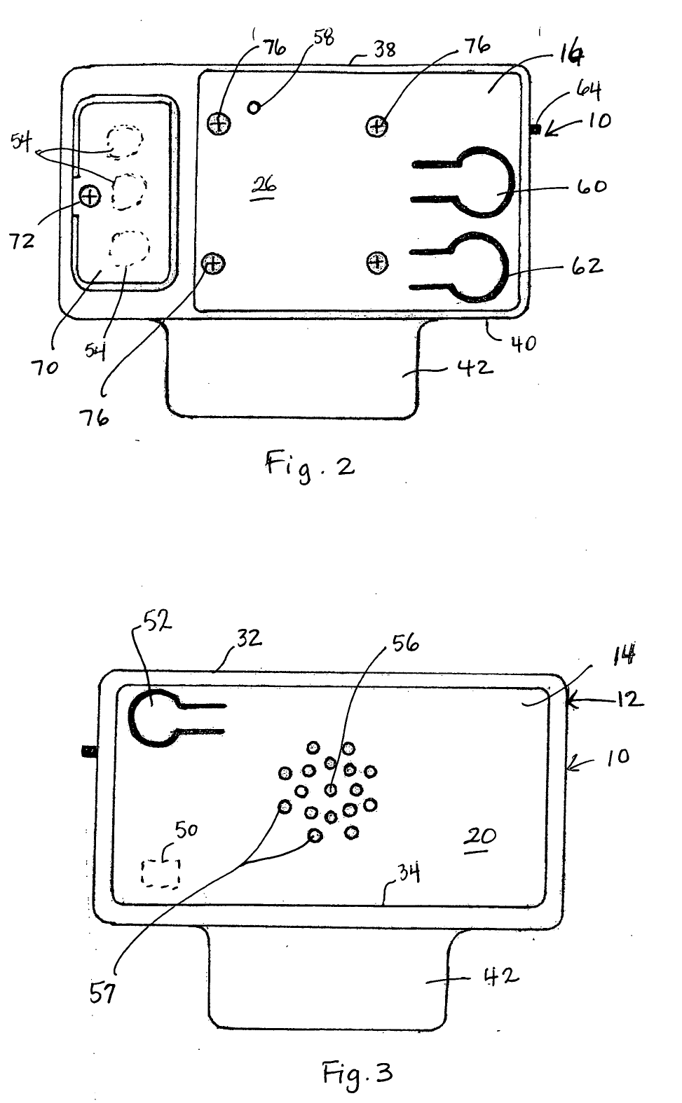

A plurality of through clustered openings 57 is formed in the front panel 14 in a surrounding relationship to the speaker 56 to allow the audio recording and to allow the recoded message stored in the memory chip of the audio board 50 to be audible to the message recipient. As can be seen in FIG. 2, the batteries 54 occupy a separate compartment, which is protected by a cover 70. The cover 70 can be removed by disengaging a screw 72 from the back panel 16. The batteries 54 can be changed, from time to time, so as to protect the audio board 50 and preserve the message recorded thereon for any desired period of time. For instance, an elderly individual may desire to leave a personal message to his/her grandchildren. The lightweight small device 10 can be used for recording the personal message and be played many times by the recipient.

The internal electronic circuitry can be accesses by removing screws 76, which attach the back panel 16 to the front panel 14 and by “opening” the plate defining the front cover 14 and the back cover 16. Of course, other mechanical engagement means may be employed instead of the screws 76. Alternatively, the casing, or housing comprised of the front panel 14 and the back cover 16 can be sealed, preventing access to the electronic components and possibility of the recorded message being erased. The only accessible compartment would be the battery compartment with the cover 70.

The instant invention utilizes digital audio technology, which can include several semiconductor chips, which permit direct recording of audio information onto the chip, and a playback of that audio information from the chip. These chips permit a consumer to record a personalized audio message. To record a message, the user moves the on/off switch 64 into the “on” position and presses the record buttons 60, 62. The user then speaks into the microphone 58 while the audio board 50 records and stores the message. Once the message has been recorded, the message sender then moves the switch 64 into the “off” position, thereby saving the energy of the batteries 54.

To play back the message, the recipient turns on the card product 10 and pushes the play button 52. The electronic circuit is energized when the play button 52 is activated. The message is then played back, with the audio signals emanating from the audio board 50 and escaping through the openings 57.

The message recorded in the memory chip may be a voice message, a musical piece, or any other sound message. The voice chip can be a one-time programmable to preserve the recorded message in a memory chip that provides high quality reproduction of the message during a playback.

When the panels 14 and 16 are joined together, the tab 42 appears on the bottom to form an attachment means that can be used for supporting the device 10. In one of the exemplary embodiments, the tab 42 can be used for supporting the device 10 on a pick 80, which is a conventional tool for supporting cards in a floral arrangement. Generally, such picks have a card-supporting top member 82 and an elongated supporting leg 84. When used with the device 10, the card-supporting member 82 of the pick 80 can be engaged with the support tab 42, and the supporting leg 84 can be forced into a piece of floral foam or soil in a flower arrangement 90. It will be understood that other means of supporting the device 10 can be used without changing the overall design of the device 10.

The present invention allows recording, storing and playing back of different sound messages, whether personal messages to a loved one, or encouragement for a bereaved, or any other type of audio communication. The device 10 provides a way to commemorate an occasion with a voice message or other sound message that can be added to flowers or other expression of an occasion to provide not only a more personal reminder of the feelings of the occasion but also a memento that can be played again and again. The device of this invention is designed so that the message can be played numerous times or indeed preserved by changing the battery.

The device 10 can be formed from molded plastic, if desired, with only access to the electronic part being the battery compartment door. The tabs 36, 42 may be formed rectangular, oval, semi-circular, or in any other desired shape. The support 80 may be made integral with the tab 42 for supporting the device 10 in a selected position. The outside surfaces 20, 26 of the front and back panels may be decorated with designs, colors, or combination thereof. The device 10 can be sent by itself, or accompany a flower arrangement, a fruit basket, or other gift for the recipient.

The size and shape of the device 10 can vary as long as it is performs the intended function of the product. The front and back panels can be square, rectangular, oval, circular, heart-shaped or other desired shapes. The device 10 can be molded into a ball, a cartoon character or some other three dimensional representation.

Many other changes and modifications can be made in the design of the present invention without departing from the spirit thereof. I therefore pray that my rights to the present invention be limited only by the scope of the appended claims.

I claim:

1. A device for delivering a personalized message, comprising:
a housing having a front panel and a back panel;
an electronic circuit positioned between the front panel and the back panel, said electronic circuit comprising an audio board enabling a sound message to be recorded and played back;
a power switch;
a power supply coupled to said power switch;
an acoustical input device coupled to said power supply and to said audio board for recoding a personalized sound message; and
an acoustical output device coupled to said power supply and to said audio board for producing an audio message recorded on said audio board.

2. The device of claim 1, wherein said power supply is positioned in a compartment accessible by a user to facilitate exchange of the power supply.

3. The device of claim 2, wherein said power supply is a replaceable battery, and said compartment is accessible from the back panel.

4. The device of claim 1, wherein the housing is provided with a tab means for supporting the housing.

5. The device of claim 1, wherein said audio board comprises a memory member for storing the recorded message.

6. The device of claim 1, wherein said electronic circuit further comprises a record switch.

7. The device of claim 1, wherein said power switch is an on/off switch operationally connected to the audio board and the power supply.

8. The device of claim 1, further comprising a play button operationally connected to the audio board.

9. The device of claim 1, wherein said acoustic input device is a microphone.

10. The device of claim 1, wherein said acoustic output device is a speaker.

11. A device for recording and delivering a personalized audio message of a sender to a recipient, comprising:
a portable housing supportable by a tab integrally connected to a wall of the housing, said housing enclosing an electronic circuit powered by an independent replaceable power supply, said electronic circuit comprising an audio board configured to selectively record and play back a personalized sound message, a microphone for recording a personalized sound message, and a speaker configured to play back the personalized recorded sound message, and
an on/off switch operationally connected to the audio board and to the power supply.

12. The device of claim 11, wherein said housing is provided with a front panel and a back panel detachably secured to the front panel.

13. The device of claim 11, further comprising a record button operationally connected to the microphone and to the audio board.

14. The device of claim 11, further comprising a play button operationally connected to the audio board and to the speaker.

15. The device of claim 12, wherein said independent power supply is positioned in a compartment accessible from the back panel.

16. A method for recording a customized audio message, said method comprising the steps of:
providing a portable housing supportable by a tab integrally connected to a wall of the housing, said housing enclosing an electronic circuit powered by an independent power supply, said electronic circuit comprising an audio board configured to record and store a personalized sound message;
providing an audio input member operable by a record button and an audio output member operable by a play button;
providing an on/off switch operationally connected to the power supply and the audio board;
moving the on/off switch into an “on” position;
manually depressing the record button and recording a customized audio message;
storing the message in the audio board for selective playback by a message recipient; and
moving the on/off switch into an “off” position, thereby disconnecting the power supply.

17. The method of claim 16, wherein said audio input member is a microphone.

18. The method of claim 16, wherein said audio output member is a speaker.

19. The method of claim 16, further comprising a step of providing a playback button enabling the message recipient to manually depress the playback button and play back the recorded stored personalized sound message.

20. The method of claim 16, wherein said power supply is a replaceable battery.
